(19) United States
(12) Patent Application Publication
(10) Pub. No.: US 2003/0048468 A1
(43) Pub. Date: Mar. 13, 2003

(54) Method of virus filtering for use in peripherals having embedded controller devices

(76) Inventors: John L. Boldon, Emmett, ID (US); David A. Martz, Boise, ID (US)

Correspondence Address: HEWLETT- PACKARD COMPANY, Intellectual Property Adminstration, P.O. Box 272400, Fort Collins, CO, 80527-2400, US

(21) Appl. No.: 09/948,825

(22) Filed: Sep. 7, 2001

(51) Int. Cl. G06F 3/12; G06F 11/00

(52) U.S. Cl. 358/1.14; 714/47

(57) ABSTRACT

This invention relates to virus filtering. Such structures of this type, generally, employ a virus filtering for use in peripherals, such as, but not limited to, printers, scanners, facsimile machines or the like. These peripherals also contain embedded controller devices, such as, but not limited to, embedded Web servers that allow the peripheral to interact with information inputting devices, such as, but not limited to, computers, word processing devices or the like.

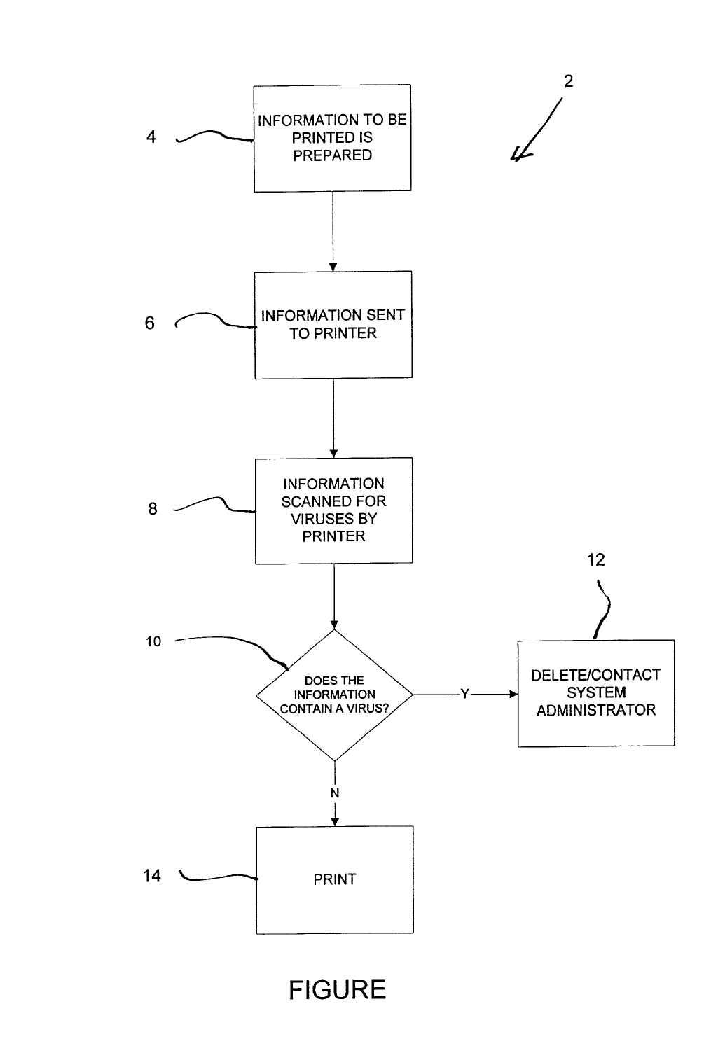

### FIELD OF THE INVENTION

This invention relates to virus filtering. Such structures of this type, generally, employ a virus filtering for use in peripherals, such as, but not limited to, printers, scanners, facsimile machines or the like. These peripherals also contain embedded controller devices, such as, but not limited to, embedded Web servers that allow the peripheral to interact with information inputting devices, such as, but not limited to, computers, word processing devices or the like.

### DESCRIPTION OF THE RELATED ART

A virus is a software program that is downloaded into a user's computer, usually unknowingly, such that the program will infect the user's computer. The effects of the virus may range from the minor to the malicious. Once the computer is infected, the virus may be spread to other computers and/or peripherals and, quite possibly, shut down the entire computing system.

It is known, in computing systems, to employ virus scanners. Exemplary of such prior art are U.S. Pat. No. 5,808,751 ('751) to G. Hochman, entitled “Method and Apparatus for Messaging of Binary Files,” U.S. Pat. No. 6,119,165 ('165) to B. Li et al., entitled “Controlled Distribution of Application Programs in a Computer Network,” and U.S. Pat. No. 6,195,767 ('767) to P. M. Adams, entitled “Data Corruption Detection Apparatus and Method.” While these references discuss the use of virus scanners in general-purpose devices used to do a variety of tasks, such as personal computers, a more advantageous scanning system would be employed if the scanning were done on any external data that would be coming into a peripheral device, such as a printer, scanner, facsimile machine or the like.

This is important in the current business environment, due to the fact that many remote peripherals, such as printing devices, scanners, facsimile machines or the like, can be connected to a single computing device. If the computing device becomes infected by a virus, then the virus could possibly spread to the peripherals, unless the data coming into the peripheral is screened/scanned by a virus protection firmware.

It is apparent from the above that there exists a need in the art for a scanning system which can be used with a peripheral device in order to scan any external data coming into a peripheral device and can be employed in conjunction with peripherals having embedded controller devices. It is the purpose of this invention to fulfill this and other needs in the art in a manner more apparent to the skilled artisan once given the following disclosure.

### SUMMARY OF THE INVENTION

Generally speaking, this invention fulfills these needs by providing a method for scanning for viruses in print jobs, comprising the steps of: preparing information to be printed; forwarding information to a printing device; scanning the information by the printing device; determining if the information substantially contains a virus; and printing the information if no virus is detected.

In certain preferred embodiments, the printing device can be, but is not limited to, a printer, a scanner, a facsimile machine or the like. Also, the print file of the information to be printed is scanned for viruses. Finally, the method also includes the step of the deleting the information if the information contains a virus and/or contacting the system administrator if a virus is found in the information.

In another further preferred embodiment, the printing device is used to scan the information to be printed in order to substantially eliminate any malicious print jobs.

The preferred virus detection method, according to this invention, offers the following advantages: ease-of-use; excellent virus detection characteristics; use of a printer to detect the virus; good stability; good durability; and excellent economy. In fact, in many of the preferred embodiments, these factors of ease-of-use, virus detection, use of a printer to detect the virus, and economy are optimized to an extent that is considerably higher than heretofore achieved in prior, known virus detection methods.

The above and other features of the present invention, which will become more apparent as the description proceeds, are best understood by considering the following detailed description in conjunction with the accompanying drawing FIGURE and in which:

### BRIEF DESCRIPTION OF THE DRAWING

The FIGURE is a flowchart that illustrates a method for detecting viruses in print jobs, according to one embodiment of the present invention.

### DETAILED DESCRIPTION OF THE INVENTION

In the past, embedded peripheral devices, such as printing devices, scanners, facsimile machines or the like were similar in that:

1.) The devices performed a single function;

2.) Jobs sent to the peripherals were self-contained (in the sense that all the information needed to process the data was contained within the data stream being processed and how the data was processed was not affected by data from previous “jobs”; and

3.) The devices did not initiate the transmission of data, but rather required an external request (in the form of incoming data or a key press) before any processing activity was performed. Virus protection was not needed for such peripheral devices because the affects of any potential virus would be limited to a single document (or request) and there would be no way for the virus to be transmitted to other devices on the network (which is one of the defining characteristics of a virus).

Modern manifestations of these types of peripheral devices have greatly expanded their functionality. They may contain disk drives allowing them to retain information from one job to the next or to have their operation changed by over-writing programs stored on the disk. They may act as file servers, keeping certain documents and other files internally and then sending them (via a network) to other devices when requested. They may have the ability to receive data in the form of programming language to be interpreted and executed by the device as new functionality, so that data received by the device can actually change the way the device performs its job. Finally, the devices may contain the ability to initiate actions and the sending of data to other devices based on any number of criteria.

Because of this expanded capability, the potential for harm from a malicious or even minor virus is greatly increased. This invention, then describes a method whereby embedded peripheral devices may be able to detect and otherwise render harmless any such virus that is received by the device.

With this background and with reference to the FIGURE, there is illustrated one preferred embodiment for use of the concepts of this invention. Due to the fact that many modern printers contain embedded controller devices, such as embedded Web servers, which allow the printers to become more multifunctional, there is currently a need for a virus detection method that can detect viruses entering into the embedded controller devices. As discussed above, there are many devices/methods for detecting viruses in general-purpose devices, such as personal computers, but there currently are no virus detection methods for use in peripherals having embedded controller devices, such as printers, scanners, facsimile machines or the like.

As shown in the FIGURE, method 2 for detecting viruses in print jobs is illustrated. Method 2, preferably, includes the steps of: preparing information to be printed (step 4); conventionally forwarding the information to the printing device (step 6); scanning the information for viruses by the printing device (step 8); determining if the information contains a virus (step 10); deleting the information and/or contacting the system administrator if a virus is found (step 12); and printing the print job if no virus is found (step 14).

With respect to step 4, the information to be printed can be conventionally prepared by any known technique, such as word processing, data entry or the like.

With respect to step 6, the information, preferably, is forwarded to a conventional embedded controller device (not shown) located in the printing device and then subsequently printed, according to conventional techniques. It is also to be understood that the information to be printed can be conventionally forwarded to the print engine (not shown) located in the printing device without having to go through the embedded controller device.

With respect to step 8, the information is scanned by scanning the print file of the information to be printed with a virus protection firmware. For example, the printing device may scan an e-mail that is to be printed. In this manner, the printing device may look at the e-mail to determine if the e-mail will print a document and not attempt to write a file to a disk in the printing device and/or general-purpose device. In short, the printing device will attempt to scan any external information coming into the printing device.

If the printing device has determined that the information to be printed contains a virus, the information can be conventionally deleted and/or the system administrator for the printing device can be conventionally contacted, as shown in step 12. In this manner, it is desired that the virus will be eliminated and/or the virus will not be introduced into other printing devices and/or general-purpose devices once a system administrator has been contacted and proper virus removal steps are taken.

If the printing device has determined that the information to be printed does not contain a virus, then the information is conventionally printed, as shown in step 14.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for scanning for viruses in print jobs, comprising the steps of:
preparing information to be printed;
forwarding the information to a printing device;
scanning the information by the printing device;
determining if the information substantially contains a virus; and
printing the information if no virus is detected.

2. The method, as in claim 1, wherein the forwarding step is further comprised of the step of:
forwarding the information to an embedded controller device located substantially within the printing device.

3. The method, as in claim 2, wherein the embedded controller device is further comprised of:
an embedded Web server.

4. The method, as in claim 1, wherein the scanning step is further comprised of the step of:
scanning a print file of the information to be printed.

5. The method, as in claim 1, wherein the method is further comprised of the step of:
deleting the information to be printed if a virus is detected in the information.

6. The method, as in claim 1, wherein the method is further comprised of the step of:
contacting a system administrator if the information to be printed contains a virus.

7. A program storage medium readable by a computer, tangibly embodying a program of instructions executable by the computer to perform method steps for scanning for viruses in print jobs, comprising the steps of:
preparing information to be printed;
forwarding the information to a printing device;
scanning the information by the printing device;
determining if the information substantially contains a virus; and
printing the information if no virus is detected.

8. The method, as in claim 7, wherein the forwarding step is further comprised of the step of:
forwarding the information to an embedded controller device located substantially within the printing device.

9. The method, as in claim 8, wherein the embedded controller device is further comprised of:
an embedded Web server.

10. The method, as in claim 7, wherein the scanning step is further comprised of the step of:
scanning a print file of the information to be printed.

11. The method, as in claim 7, wherein the method is further comprised of the step of:
deleting the information to be printed if a virus is detected in the information.

12. The method, as in claim 7, wherein the method is further comprised of the step of:
contacting a system administrator if the information to be printed contains a virus.
